(19) United States
(12) Patent Application Publication
(10) Pub. No.: US 2010/0004080 A1
(43) Pub. Date: Jan. 7, 2010

(54) PRESSURE RELIEF VALVE FOR A HYDRAULIC TENSIONER

(75) Inventor: Simon Xunnan HE, TROY, MI (US)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/495,970

(22) Filed: Jul. 1, 2009

Related U.S. Application Data
(60) Provisional application No. 61/077,512, filed on Jul. 2, 2008.

(51) Int. Cl. F16H 7/08; F16K 17/04

(52) U.S. Cl. 474/110; 137/535

(57) ABSTRACT

The relief valve uses a slotted Belleville spring preloaded in a cage. The center area of the spring is closed and presses a hole in the bottom wall of the cage. The top wall of the cage is open and has a ledge against which the radial end of the spring presses. The relief valve is used in a hydraulic tensioner and positioned in the tensioner to have the bottom wall form a wall of the pressure chamber. When the pressure in the pressure chamber exceeds the pressure of the spring against the hole, fluid leaks out of the hole.

### FIELD OF THE INVENTION

This Invention relates to tensioners and, more particularly, to hydraulic chain tensioners used in automobiles for timing chains and a pressure relief valve used in the hydraulic chain tensioners.

### BACKGROUND OF THE INVENTION

Timing chain drives in an automotive engine are endless loops and transmit power from a crankshaft to camshafts. To prevent tooth jump in a chain drive, hydraulic tensioners are applied to provide initial tension in the chain drive. Typically, a hydraulic tensioner works in conjunction with a movable chain guide in the slack side of a chain drive and takes up excess slack in the chain drive to keep the chain in a desired tensioned state. A typical hydraulic tensioner contains a housing with a bore; a hollow piston in the bore forming a pressure chamber; a spring mounted in the bore to push the piston outwards; and a check valve. The check valve provides pressurized supply fluid from an external source of pressurized fluid to the chamber. The pressurized fluid in the chamber then pushes the piston outward to generate initial tension in the chain.

When the crankshaft drives the camshafts, both crankshaft driving power and camshaft loads from the valve trains are oscillatory and cause the chain forces to oscillate. When the chain force decreases, the check valve of the tensioner opens and the piston is pushed outward by the piston spring and the pressurized fluid supplied to the pressure chamber through the check valve from the external source. When the chain force increases and pushes the piston inwards, the check valve closes and the pressure in the chamber increases. For some engine operation conditions, the pressure in the chamber can be excessively high and cause excessively high chain force. This problem has been solved by adding a pressure relief valve to the tensioner. The pressure relief valve opens and upon reaching a predetermined pressure in the pressure chamber, fluid leaks out of the chamber. The fluid leakage keeps the pressure in the chamber from exceeding a preset value and so reduces the maximum chain force.

Current pressure relief valves use separate springs and moving objects, such as a ball, a pin with a cap, or a hollow piston, either on the piston or on the housing, see, for example:

U.S. Pat. Nos. 7,108,621, 6,193,623, and 5,700,213 which teach a wire spring plus a ball as pressure relief valves;

U.S. Pat. No. 6,716,124 and U.S. Patent Application 20030195070 which teach another piston and a spring on the primary piston as pressure relief; and

U.S. Pat. Nos. 6,383,103, 6,361,458, 6,322,468, 5,879,256, and 5,577,970 which teach a spring and other shape objects including a ball as pressure relief valve.

All these designs have separate springs and relatively heavier objects as the pressure relief valve. When the valve opens for pressure relief, the fast motion makes them oscillate and generate sever pressure oscillation in the pressure chamber. Also, for high relief pressure, the spring designs require too much space.

### OBJECTS OF THE INVENTION

It is the object of the Invention to reduce the oscillation of the relief valve during opening and to prove a simpler design with fewer moving parts. It is also the objects of the Invention to provide a relief valve that opens at a higher pressure while reducing the size and weight of the relief valve.

These and other objects of the Invention are apparent from the following description.

### SUMMARY OF THE INVENTION

The objects of the Invention are achieved by employing a slotted Belleville spring as the moving component in the pressure relief valve for opening and closing the relief valve and allowing pressurized fluid to pass through the relief valve.

Broadly, the pressure relief valve for a chain tensioner comprises:
a cage, having a bottom wall with a center hole therein, side walls and a top wall with an opening therein and an inward lateral ledge; and
a slotted Belleville spring mounted in the cage, the spring having a closed center area, a convex side of the closed center area pressing against and fluidly sealing the hole in the bottom wall of the cage,
the spring having an outer radial end pressing against the ledge of the top wall of the cage.

When the pressure in the hole against the center area of the spring exceeds the preset valve, the spring flexes inward allowing the closed center area to lift off and unseal the hole and for fluid to leak through the hole and the slots in the spring. When the pressure in the hole against the center area of the spring is at or below the preset valve, the flex in the spring seals the hole due to the closed center area pressing against the hole and prevents fluid moving through the hole.

The cage has a bottom wall, side walls and a top wall The cage is designed to mount in the bore in the housing. Since the bore has a cylindrical shape, the cage is also cylindrical in shape with a circular top and bottom wall and cylindrically shaped side walls. The distance between the top and bottom wall preloads the spring, to fluidly seal the hole.

A hole is in the center of the bottom wall while the top wall is open. The remaining portion of the top wall defines a lateral ledge.

The slotted Belleville spring has a convex, general frustum cross-sectional shape (frusto-conical). The top of the frustum being closed and generally flat for sealing the hole. The side walls of the frustum are arched radially and axially outward to an outer radial end. There are slots, perforations or holes in the side walls of the spring to allow for fluid to leak out of the valve when the seal between the closed center area and the hole is open.

The slots can take any shape, suitably wedge or helically spiral. The slots are delimited by solid segments of the side wall of the frustum, which can also be defined as legs.

Preferably, the frustum walls have wedge shaped slots that are delimited by three legs which extend, but do not touch the cylindrical side wall of the cage. More preferably, the legs have feet which extend outward from the side walls of the frustum.

The edge of the hole abutting the center of the spring can be slanted to provide for a better seal between the arched convex closed center area end of the spring and the hole.

Preferably, the convex side of the closed center area has a ring that encircles the hole to seal the hole.

The spring is made in a conventional manner using conventional equipment.

A tensioner using the relief valve of the present Invention can be defined as a tensioner for a chain comprising:
(a) a housing having a bore therein;
(b) a hollow piston slidably mounted in the bore and spring loaded in a direction towards one end of the housing, the piston and housing defining a pressure chamber;
(c) a check valve mounted in the other end of the housing for fluid communication between the pressure chamber and an external source of pressurized fluid; and
(d) a pressure relief valve mounted in the one end of housing and in fluid communication with the pressure chamber for release of fluid from the pressure chamber;
   wherein the pressure relief valve comprises:
(d1) a cage having a bottom wall that seals the one end of the pressure chamber, and a top wall with an opening therein; the bottom wall of the cage having a center hole and the top wall of the cage having an inward, radial ledge;

(d2) a slotted Belleville spring mounted in the cage with a convex side of a center closed area of the spring pressing against the hole to seal the hole and the radial end of the spring pressing against the ledge.

### BRIEF DESCRIPTION OF THE DRAWINGS

The above and other objects, features and advantages of the Invention may be more fully understood by reference to one or more of the following drawings:

FIG. 1 is a cutaway perspective of the relief value of the Invention;

FIG. 2 is a top view of the valve;

FIG. 3 is a cutaway perspective of the relief valve with a ring on the convex side of the center area of the spring;

FIG. 4 is a cross section of the tension wherein the relief valve is closed; and

FIG. 5 is a cross section of the tensioner wherein the relief valve is open.

### DETAILED DESCRIPTION OF THE INVENTION

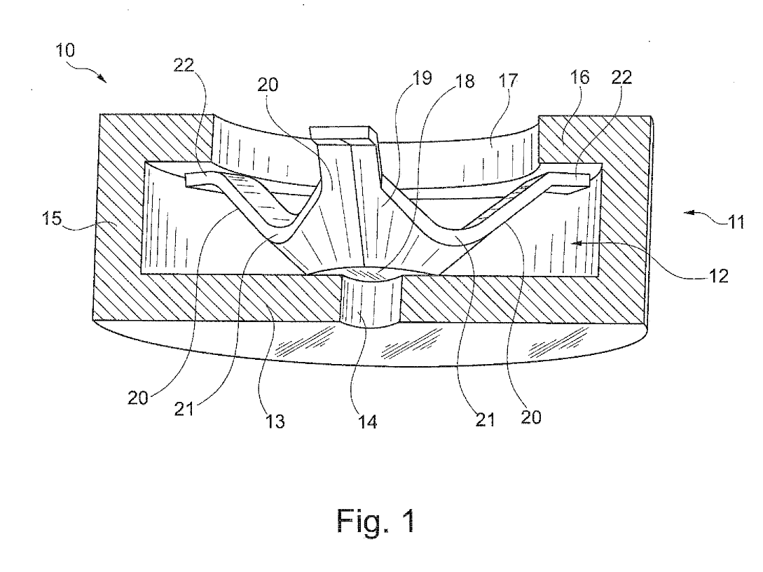

FIG. 1 illustrates relief valve 10 of the present Invention. Relief valve 10 has cage 11 and slotted Belleville spring 12 prestressed therein. Cage 11 has a bottom wall 13 and a hole 14 centered within bottom wall 13. Side wall 15 of cage 11 extends upward from bottom wall 13. Top wall 16 has an opening 17. Top wall 16 takes the form of an inward radial ledge extending laterally from side wall 15. Cage 11 has an overall cylindrical shape. The interior of cage 11 also has a cylindrical shape in which spring 12 is housed.

Spring 12 has a closed center area 18 and side wall 19 which extend upward from center area 18. The overall shape of spring 12 is that of a frustum. Side wall 19 has leg 20 which define slot 21. Slot 21 is generally wedge shaped. Leg 20 terminates in a foot 22 which radially extends outward from leg 20.

Foot 22 presses against ledge portion of top wall 16 and center area 18 presses against bottom wall 13 to fluidly seal hole 14.

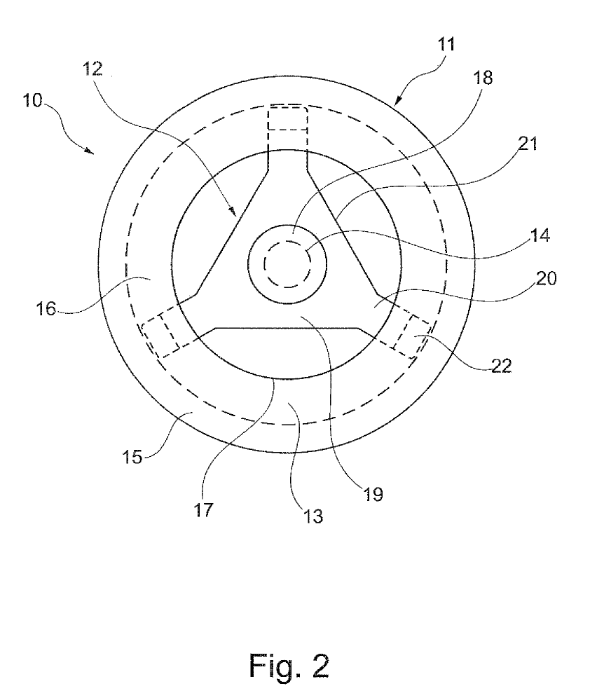

Turning to FIG. 2, this is a top view of relief valve 10. As can be seen, there are three legs 20. Center area 18 covers hole 14.

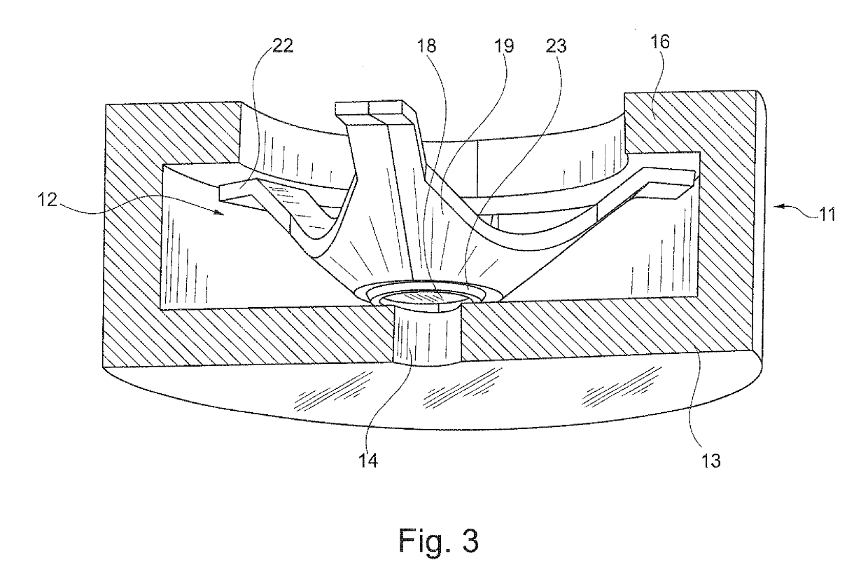

FIG. 3 illustrates an alternative where ring 23 is affixed to center area 18. Ring 23 encircles hole 14 and forms a seal between spring 12 and bottom wall 13. This seal is a fluid tight seal.

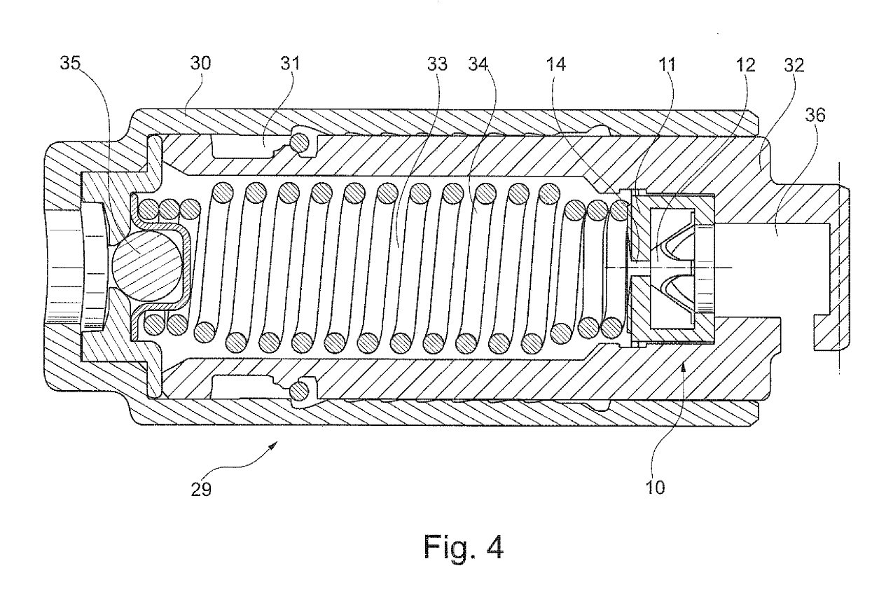

Turning to FIG. 4, this illustrates relief valve 10 in hydraulic tensioner 29. Hydraulic tensioner 29 has a housing 30 with bore 31 therein. Hollow piston 32 is mounted in bore 31 and spring loaded by spring 33 in bore 31. The space defined by bore 31 and the hollow portion of piston 32 defines a pressure chamber 34. Check valve 35 provides fluid communication between an external fluid source and pressure chamber 34. Check valve 35 operates in a conventional manner to allow for the entry of fluid into pressure chamber 34 but prevents fluid from exiting pressure chamber 34. Hollow piston 32 is shown with outlet 36 for fluid which escapes out of relief valve 10 when the pressure in pressure chamber 34 exceeds a preset value.

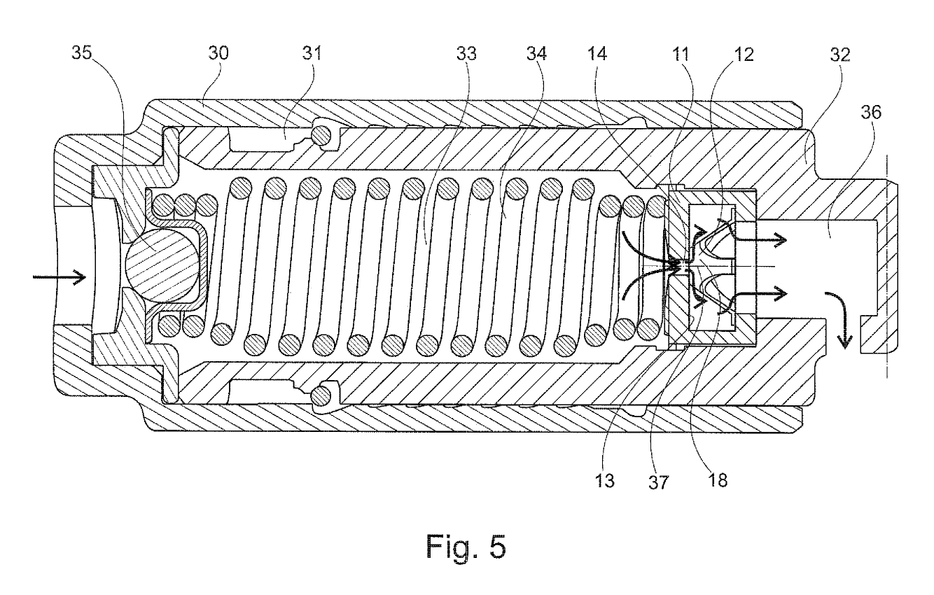

The arrows in FIG. 5 illustrates the flow of fluid into pressure chamber 34 through check valve 35 and out of pressure chamber 34 through relief valve 10. FIG. 5 illustrates gap 37 which forms between center area 18 and bottom wall 13 when the fluid pressure in pressure chamber 34 exceeds the preset value. Gap 37 allows for the leakage of oil out of pressure chamber 34 and, thus, the reduction of the fluid pressure.

During the compression stroke of piston 32, the pressure inside pressure chamber 34 will increase. The pressure increase is proportional to the velocity of the compression stroke of piston 32. The pressure also applies against center area 18 of spring 12 through hole 14 of cage 11. When the piston stroke velocity increases to a certain value, the increase pressure applied to spring 12 balances the preload between spring 12 and cage 11. When the pressure exceeds the preload pressure, spring 12 no longer seals hole 14 and oil and fluid leaks out of pressure chamber 34. After the leakage of fluid through the pressure relief valve 10, the pressure inside chamber 34 reduces and spring 12 flexes back to seal hole 14. This process keeps the pressure inside chamber 34 below a preset value during the entire compression stroke of piston 32.

As can be seen, pressure relief valve 10 can be employed in a variety of different chain tensioners, provided bottom wall 13 acts as one of the walls inside pressure chamber 34.

### REFERENCE CHARACTERS

10 Relief valve
11 Cage
12 Slotted Belleville spring
13 Bottom wall of cage
14 Hole
15 Side wall of cage
16 Inward radial top wall
17 Opening in top wall
18 Center area of spring
19 Side wall of spring
20 Leg
21 Slot
22 Foot
23 Ring
29 Hydraulic tensioner
30 Housing
31 Bore
32 Hollow piston
33 Spring
34 Pressure Chamber
35 Check Valve
36 Outlet
37 Gap

I claim:

1. A tensioner for a chain comprising:
(a) a housing having a bore therein;
(b) a hollow piston slidably mounted in the bore and spring loaded in a direction towards one end of the housing, the piston and housing defining a pressure chamber;
(c) a check valve mounted in the other end of the housing for fluid communication between the pressure chamber and an external source of pressurized fluid; and
(d) a pressure relief valve mounted in the one end of housing and in fluid communication with the pressure chamber for release of fluid from the pressure chamber;
wherein the pressure relief valve comprises:
(d1) a cage having a bottom wall that seals the one end of the pressure chamber, and a top wall with an opening therein; the bottom wall of the cage having a center hole arid the top wall of the cage having an inward, radial ledge;
(d2) a slotted Belleville spring mounted in the cage with a convex side of a center closed area of the spring pressing against the hole to seal the hole and the radial end of the spring pressing against the ledge.

2. The tensioner of claim 1, wherein
the spring has a center area that is flat for sealing the hole, and
radial legs extending outward radially and axially from the center area, the slots defined by the area between the legs.

3. The tensioner of claim 2, wherein
the slots are helical.

4. The tensioner of claim 2, wherein
the slots are wedges.

5. The tensioner of claim 2, wherein
there are three legs.

6. The tensioner of claim 2, wherein
the legs have outward radial feet that abut the ledge.

7. The tensioner of claim 2, wherein
the convex side of the center area has a ring that encircles the hole and abuts the bottom wall of the cage.

8. A pressure relief valve comprising:
a cage having a bottom wall, side walls and a top wall, the bottom wall having a center hole therein, the top wall having an opening therein and the top wall having an inward lateral ledge; and
a slotted Belleville spring mounted in the cage, the spring having a closed center area, a convex side of the closed center area pressing against and fluidly sealing the hole, and the spring having an outer radial end pressing against the ledge.

9. The valve of claim 8, wherein
the center area is flat.

10 The valve of claim 8, wherein
a ring is affixed to the center area and the ring encircles the hole.

11. The valve of claim 8, wherein
the slots are wedge shaped and between each slot is a leg that extends radially and axially outward from the center area to contact the ledge.

12. The valve of claim 11, wherein
each leg has an outward radial foot that contacts the ledge.

13. The valve of claim 11, wherein
the spring has three legs.
